(19) United States
(12) Patent Application Publication
(10) Pub. No.: US 2012/0098378 A1
(43) Pub. Date: Apr. 26, 2012

(54) MOTOR

(75) Inventors: Yoshiaki TAKEMOTO, Toyohashi-shi (JP); Toshihiro UCHIDA, Nagoya-shi (JP); Shigemasa KATO, Toyohashi-shi (JP)

(73) Assignee: ASMO CO, LTD., Shizuoka-ken (JP)

(21) Appl. No.: 13/274,064

(22) Filed: Oct. 14, 2011

(30) Foreign Application Priority Data
Oct. 25, 2010 (JP) 2010-238713
Oct. 5, 2011 (JP) 2011-221223

(51) Int. Cl. H02K 1/27

(52) U.S. Cl. 310/156.53

(57) ABSTRACT

A motor includes a rotor of 4n magnetic poles and a stator. The rotor includes a rotor core, 2n magnets embedded in the rotor core and 2n salient pole portions formed integrally with the rotor core. A gap is formed between each magnet and the circumferentially adjacent salient pole portion. The stator has 6n tooth portions arranged to face the magnets and the salient pole portions in the radial direction, and coils. Each coil is wound about one of the tooth portions. An electric angle α that corresponds to a mechanical angle α′ defined by a reference line that passes through a central axis of the rotor and the circumferential center position of each magnet, and a line that passes through the central axis of the rotor and the trailing end of each trailing gap, is set in the range of 90°<α<126°.

### BACKGROUND OF THE INVENTION

The present invention relates to a motor having a rotor of a consequent-pole structure.

Conventionally, motors having a rotor of a consequent-pole structure as disclosed in, for example, Japanese Laid-Open Utility Model Publication No. 4-34835 are known. A rotor having a consequent-pole structure includes a plurality of magnets arranged in the circumferential direction of a rotor core, which have one magnetic polarity, and salient pole portions integrated with the rotor core arranged between adjacent magnets. The salient pole portions have the other magnetic polarity.

The rotor of a motor disclosed in Japanese Laid-Open Utility Model Publication No. 4-34835 includes two magnets and two salient pole portions. The magnets have the same polarity on the radially outer sides and are arranged at opposite positions spaced by substantially 180°. The salient pole portions are each spaced from the magnets and located between the two magnets. The radially outer side of the salient pole portions has the same polarity.

A motor that has a rotor of the above described consequent-pole structure has a stator that faces the rotor in the radial direction. The stator has tooth portions that extend toward the rotor. For example, in a case where the rotor of a consequent-pole structure has four magnetic poles, a stator having six tooth portions may be assembled with the stator. In such a motor, which has a rotor of a consequent-pole structure with four magnetic poles and a stator with six tooth portions, it is desired to increase the torque and to reduce torque ripple, which can cause motor vibrations.

Similarly, in a motor, which has a rotor with magnetic poles, where the number of the magnetic poles is represented by 4n and the value n is a positive integer, and a stator with tooth portions, where the number of the tooth portions is represented by 6n, it is desired to increase the torque and to reduce torque ripple, which can cause motor vibrations.

### SUMMARY OF THE INVENTION

Accordingly, it is an objective of the present invention to increase the torque and reduce torque ripple in a motor having a rotor with 4n magnetic poles and a stator with 6n tooth portions.

To achieve the foregoing objective and in accordance with one aspect of the present invention, a motor that includes a rotor of magnetic poles and a stator having tooth portions and coils is provided. The number of the magnetic poles is represented by 4n, where the value n is a positive integer. The number of the tooth portions is represented by 6n. The rotor has a rotor core, magnets, and salient pole portions. The numbers of the magnets and the salient pole portions are both represented by 2n. The magnets are arranged along the circumferential direction of the rotor core and embedded in the rotor core to function as 2n of the magnetic poles having one magnetic polarity. The salient pole portions are arranged along the circumferential direction and integrally formed with the rotor core. Each salient pole portion is located circumferentially between the magnets. The salient pole portions function as 2n of the magnetic poles having the other magnetic polarity, and a gap is provided between each magnet and a circumferentially adjacent one of the salient pole portions. The tooth portions are arranged circumferentially at equal intervals to face the magnets and the salient pole portions in the radial direction, and each coil is wound about one of the tooth portions. The gaps located at the circumferential ends of each magnet include a trailing gap, which is on a trailing side of the magnet. An electric angle α that corresponds to a mechanical angle α′ defined by a reference straight line, which passes through a central axis of the rotor and the circumferential center position of each magnet, and a straight line, which passes through the central axis of the rotor and a trailing end of each trailing gap, is set in the range of 90°<α<126°.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1A is a schematic diagram of a motor according to a first embodiment of the present invention;

FIG. 1B is an enlarged diagram of a part of the rotor in FIG. 1A;

FIG. 2 is a graph showing changes in the torque and torque ripple in relation to changes in an electric angle α;

FIG. 3 is a graph showing changes in the torque and torque ripple in relation to changes in an electric angle β;

FIG. 4 is a graph illustrating changes in the torque according to the structure of a motor;

FIG. 5 is a graph illustrating changes in the torque ripple according to the structure of a motor;

FIGS. 6 to 8 are diagrams each describing a rotor of a modification;

FIG. 9A is a schematic diagram of a motor according to a second embodiment of the present invention;

FIG. 9B is an enlarged diagram of a part of the rotor in FIG. 9A; and

FIGS. 10 to 12 are diagrams each describing a rotor of a modification.

### DETAILED DESCRIPTION OF THE PREFERRED EMBODIMENTS

A first embodiment of the present invention will now be described with reference to the drawings.

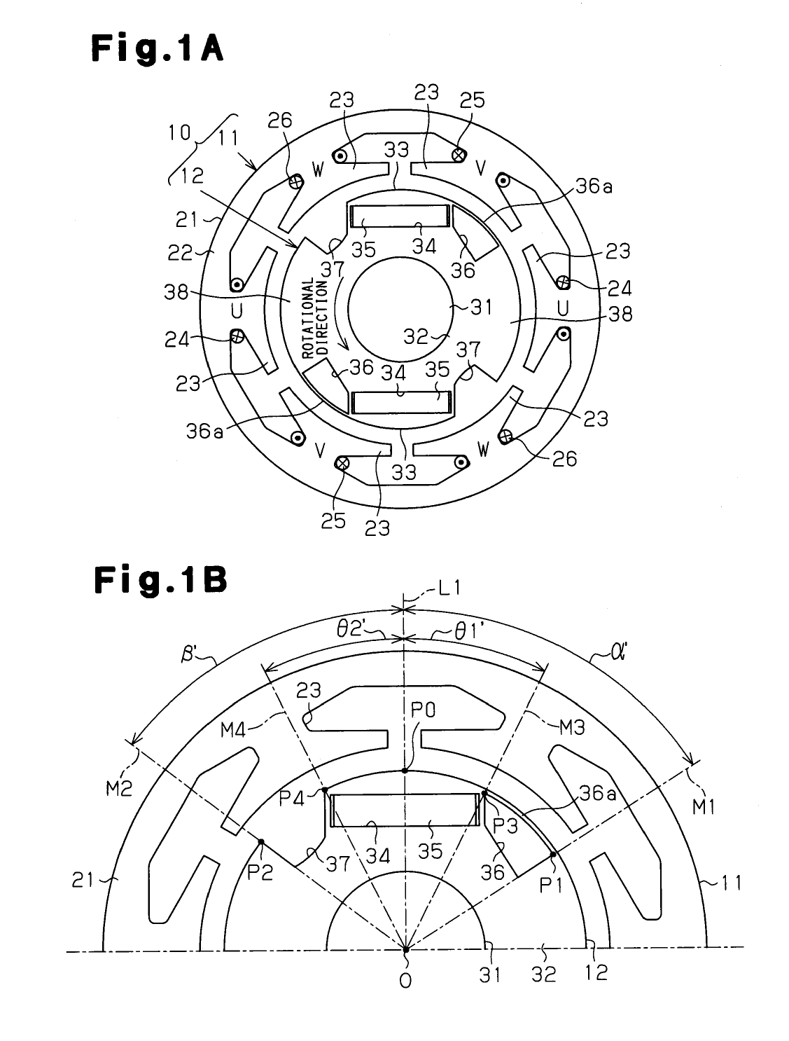

As shown in FIG. 1A, a motor 10 of the present embodiment includes a substantially annular stator 11 and a rotor 12 arranged radially inward of the stator 11.

The stator 11 has a stator core 21, which includes an annular portion 22 and six tooth portions 23 extending radially inward from the annular portion 22. The tooth portions 23 are formed at equal angular intervals in the circumferential direction of the annular portion 22. One of coils 24, 25, 26 of the U-phase, V-phase, and W-phase is wound about each tooth portion 23 by concentrated winding. Of the coils 24, 25, 26 of three phases, the coils in each set of the same phase are arranged at a circumferential interval of the mechanical angle of 180° and are connected in series. The coils of the three phases are electrically connected via a delta connection.

The rotor 12 has a rotary shaft 31, which is rotatably supported by bearings (not shown), and a substantially annular rotor core 32, which is made of magnetic metal fixed to the outer circumferential surface of the rotary shaft 31. Magnetic pole portions 33 (the number of which is two in the present embodiment) are formed in the outer periphery of the rotor core 32. The magnetic pole portions 33 face the tooth portions 23 of the stator 11 in the radial direction.

Two accommodation holes 34 are formed in the magnetic pole portions 33 of the rotor core 32 at positions spaced by the mechanical angle of 180° in the circumferential direction and at radially outer positions of the rotor core 32. Each accommodation hole 34 extends through the rotor core 32 in the axial direction (the direction perpendicular to the sheet of the drawing). A magnet 35 is accommodated in each accommodation hole 34. That is, the motor 10 of the present embodiment is an IPM motor having the rotor 12 with embedded magnets. The radially outer surfaces of the magnets 35 have the same polarity.

Gaps 36, 37, which create magnetic resistance, are formed at circumferential ends of each magnetic pole portion 33. Thus, salient pole portions 38 (the number of which is two in the present embodiment) are formed between the magnetic pole portions 33. Each salient pole portion 38 is magnetically partitioned from the magnetic pole portions 33. That is, the magnetic flux of each magnetic pole portion 33 flows into each salient pole portion 38 via the inner part of the rotor core 32, while bypassing the gaps 36, 37 formed at the circumferential ends. The magnetic flux passes radially outward through the salient pole portions 38. Accordingly, each salient pole portion 38 functions as a pseudo-magnetic pole that has a different polarity from the adjacent magnetic pole portions 33.

The rotor 12 of the present embodiment is configured as a consequent pole rotor. Thus, compared to a normal multipolar motor (brushless motor), in which all the magnetic poles of a rotor 12 are formed by magnets arranged at positions of the magnetic poles, the present embodiment permits a reduction in the size and an increase in the output, as in the multipolar motor, while reducing the amount of magnets used by half.

In the following description, the motor 10 of the present embodiment is set to rotate in one direction (counterclockwise direction as viewed in FIG. 1A). Hereinafter, of the two types of gaps 36, 37 on the circumferential ends of each magnetic pole portion 33, the gaps 37 on the leading side of the magnetic pole portions 33 will be referred to as a “leading gaps (or first gaps)”, and the gaps 36 on the trailing side of the magnetic pole portions 33 will be referred to as “trailing gaps (or second gaps)”. Each leading gap 37 is formed to open radially outward. On the radially outer side (outer circumferential side), each trailing gap 36 is closed by a coupling portion 36a that connects the magnetic pole portion 33 and the salient pole portion 38. That is, the coupling portions 36a closing the trailing gaps 36 and the outer circumferential surfaces of the magnetic pole portions 33 and the salient pole portions 38 are on the same circle.

The optimal design of the electric angles α, β that correspond to mechanical angles α′, β′ that define the circumferential dimensions of the gaps 36, 37 formed at the circumferential ends of each magnetic pole portion 33 will now be described. As shown in FIG. 1B, the trailing end of each trailing gap 36 will be referred to as a “trailing end (or a first end) P1”, and the leading end will be referred to as a “leading end (or a second end) P3.” Also, the trailing end of each leading gap 37 will be referred to as a “trailing end (or a first end) P4”, and the leading end will be referred to as a “leading end (or a second end) P2.” The electric angle α corresponds to the mechanical angle α′ that is an angle defined by a reference straight line L1, which passes through the central axis O of the rotor 12 and the circumferential center position P0 of the magnetic pole portion 33, and a straight line M1, which passes through the central axis O of the rotor 12 and the trailing end P1 of the trailing gap 36. Likewise, the electric angle β corresponds to the mechanical angle β′ that is an angle defined by the reference straight line L1 and a straight line M2, which passes through the central axis O of the rotor 12 and the leading end P2 of the leading gap 37. The reference straight line L1 also passes substantially through the circumferential center of the magnet 35.

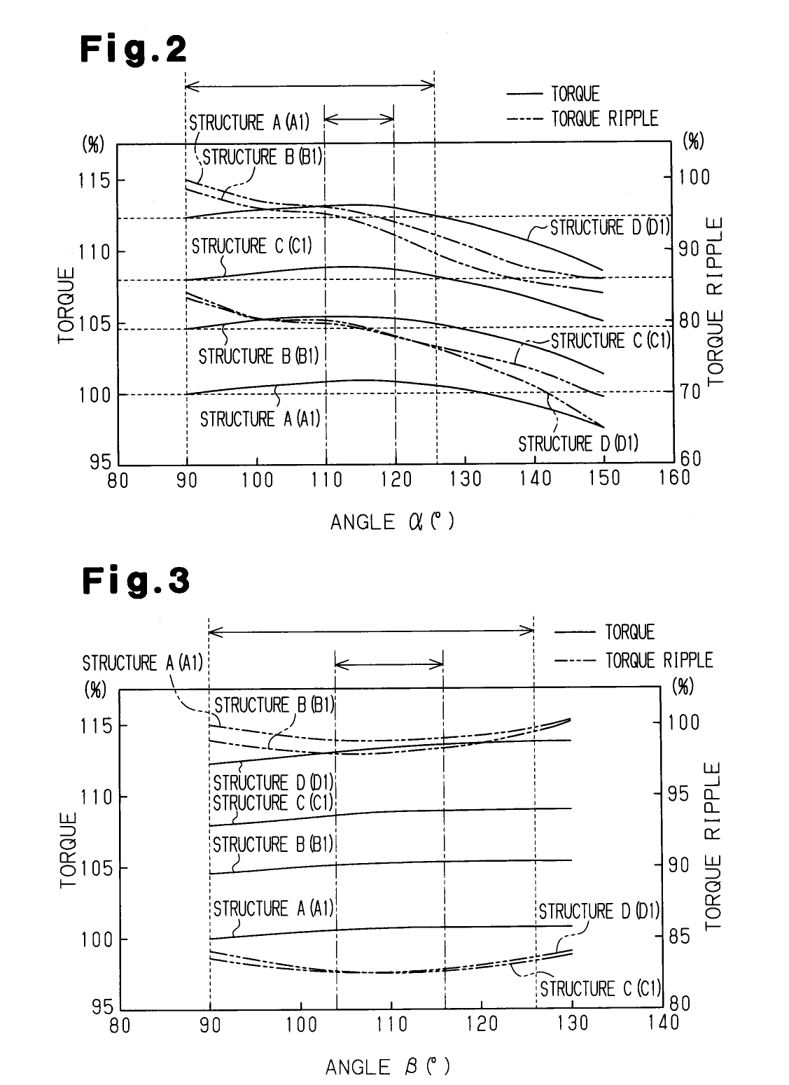

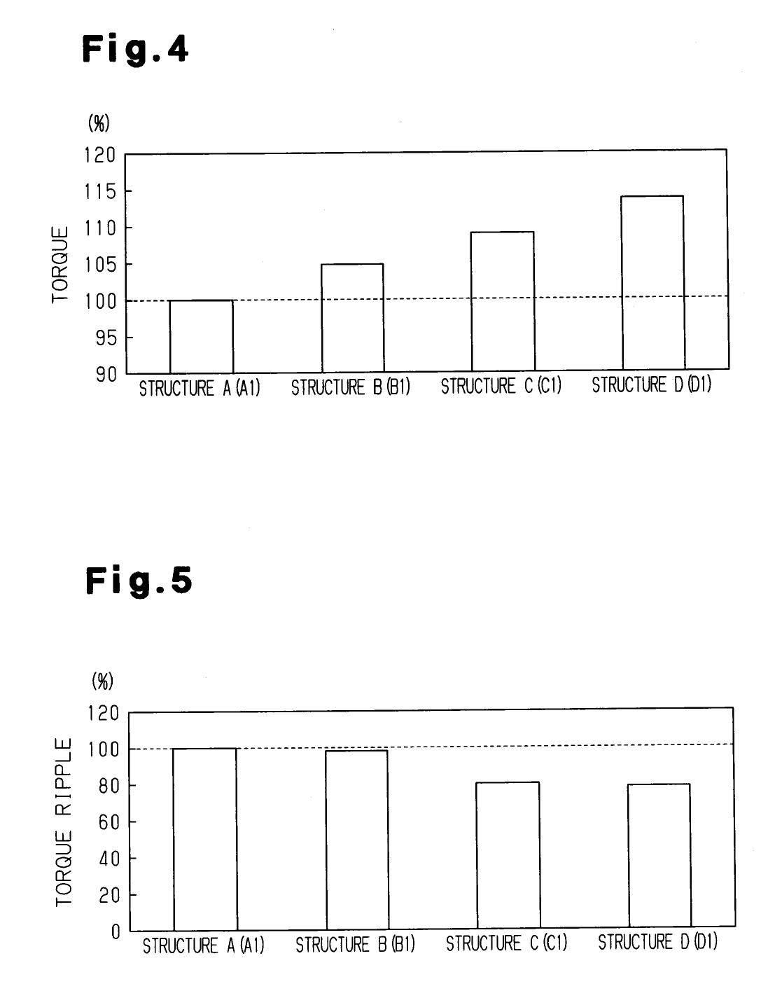

FIG. 2 is a graph showing the relationship between the electric angle α, which corresponds to the mechanical angle α′ that defines the circumferential dimension of each trailing gap 36, and the torque and torque ripple of the motor 10. FIG. 3 is a graph showing the relationship between the electric angle β, which corresponds to the mechanical angle β′ that defines the circumferential dimension of each leading gap 37, and the torque and torque ripple of the motor 10. FIG. 2 shows the results of simulation that was performed with the electric angle β fixed to a reference electric angle of 90°, which corresponds to the mechanical angle of 45°. On the other hand, FIG. 3 shows the results of simulation that was performed with the electric angle α fixed to a reference electric angle of 90°, which corresponds to the mechanical angle of 45°. The rotor 12 of the present embodiment corresponds to “Structure C” in FIGS. 2 and 3.

According to FIG. 2, the motor 10 generates a higher torque in the range of 90°<α<126° (45°<α′<63°), than when the electric angle α=90° (α′=45°). Also, the torque ripple is lower in the range of 90°<α<126° (45°<α′<63°) than when the electric angle α=90° (α′=45°). Further, in the range of 110°≦α≦120° (55°≦α′≦60°), a higher torque can be generated. Therefore, the electric angle α, which corresponds to the mechanical angle α′ that defines the circumferential dimension of each trailing gap 36, is preferably set in the range of 90°<α<126° (45°<α′<63°), and more preferably in the range of 110°≦α≦120° (55°≦α′≦60°).

According to FIG. 3, the motor 10 generates a higher torque in the range of 90°<β<126° (45°<β′<63°), than when the electric angle β=90° (β′=45°). Also, the torque ripple is lower in the range of 90°<β<126° (45°<β′<63°) than when the electric angle β=90° (β′=45°). Further, in the range of 104°≦β≦116° (52°≦β′≦58°), a relatively high torque can be generated and the torque ripple can be reliably reduced. Therefore, the electric angle β, which corresponds to the mechanical angle β′ that defines the circumferential dimension of each leading gap 37, is preferably set in the range of 90°<β<126° (45°<β′<63°), and more preferably in the range of 104°≦β≦116° (52°≦β′≦58°).

Taking the above results into consideration, the electric angles α, β of the rotor 12 in the present embodiment are determined in the following manner. In the rotor 12 of the present embodiment, the electric angle a that corresponds to the mechanical angle α′ of the trailing gaps 36 is set to substantially 115° (α′=57.5°), and the electric angle β that corresponds to the mechanical angle β′ of the leading gaps 37 is set to substantially 105° (β′=52.5°). Therefore, the circumferential dimension (the mechanical angle α′ corresponding to the electric angle α) of the trailing gaps 36 is greater than the circumferential dimension (the mechanical angle β′ corresponding to the electric angle β) of the leading gaps 37. In the present embodiment, an electric angle θ1 that corresponds to the mechanical angle θ1′ that is an angle defined by the reference straight line L1, which passes through the central axis O of the rotor 12 and the circumferential center position P0 of the magnetic pole portion 33, and a straight line M3, which passes through the central axis O of the rotor 12 and the leading end P3 of the trailing gap 36, is set to 50.2° (θ1′=25.1°). Likewise, an electric angle θ2 that corresponds to the mechanical angle θ2′ that is an angle defined by the reference straight line L1, which passes through the central axis O of the rotor 12 and the circumferential center position P0, and a straight line M4, which passes through the central axis O of the rotor 12 and the trailing end P4 of the leading gap 37, is set to 50.2° (θ2′=25.1°). That is, the mechanical circumferential angle of each magnetic pole portion 33 is set to 50.2°, which corresponds to an electrical angle of 100.4°.

As described above, the electric angle α, which corresponds to the mechanical angle that defines the circumferential dimension of the trailing gaps 36, is set to 115° (α′=57.5°), which is in the range of 110°≦α≦120° (55°≦α′≦60°), and the electric angle β, which corresponds to the mechanical angle that defines the circumferential dimension of the leading gaps 37, is set to 105° (β′=52.5°), which is in the range of 104°≦β≦116° (52°≦β′≦58). Accordingly, the torque of the motor 10 is increased while the torque ripple is reduced, compared to a case where the electric angles α, β are 90° (α′, β′=45°).

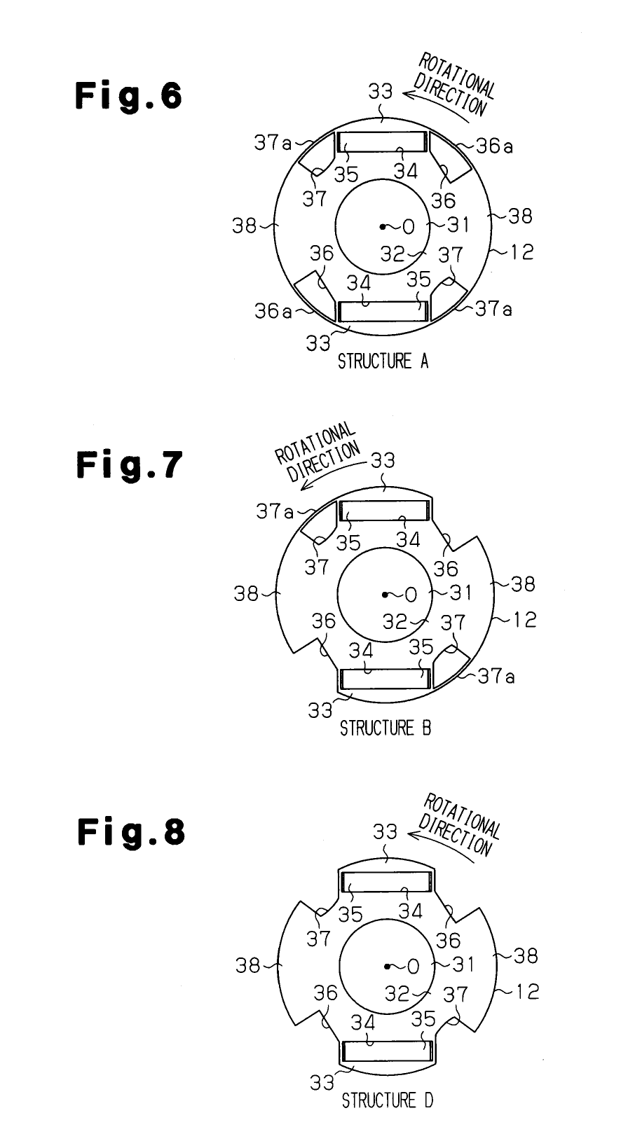

In the rotor 12 of the present embodiment, each leading gap 37 is open radially outward, and the trailing gaps 36 are closed by the coupling portions 36a. In this case, the rotor 12 of the present invention (Structure C) generates greater torque and reduces the torque ripple compared to a rotor shown in FIG. 6 (Structure A), in which gaps 36, 37 are both closed by coupling portions 36a, 37a, and a rotor shown in FIG. 7 (Structure B), in which each leading gap 37 is closed by a coupling portion 37a and each trailing gap 36 opens radially outward. Also, compared to, for example, a rotor shown in FIG. 8 (Structure D), in which both gaps 36, 37 are open, the rotor 12 of the present embodiment has a higher strength since the gaps 36 are closed by the coupling portions 36a.

Next, advantages of the present embodiment will be described.

(1) The electric angle a that corresponds to the mechanical angle α′ defined by the reference straight line L1, which passes through the central axis O of the rotor 12 and the circumferential center position P0 of the magnetic pole portion 33, and the straight line M1, which passes through the central axis O of the rotor 12 and the trailing end P1 of the trailing gap 36 is set in the range of 90°<α<126°. Accordingly, as shown in FIG. 2, the torque is increased and the torque ripple is reduced compared to the case where α=90°.

(2) Also, when the electric angle α is in the range of 110°≦α≦120°, the torque is reliably increased while the torque ripple is reduced, compared to the case where the electric angle α is 90°, as shown in FIG. 2.

(3) The electric angle β that corresponds to the mechanical angle β′ defined by the reference straight line L1, which passes through the central axis O of the rotor 12 and the circumferential center position P0 of the magnetic pole portion 33, and the straight line M2, which passes through the central axis O of the rotor 12 and the leading end P2 of the leading gap 37 is set in the range of 90°<β<126°. Accordingly, as shown in FIG. 3, the torque is increased and the torque ripple is reduced compared to the case where β=90°.

(4) When the electric angle β is in the range of 104°≦β≦116°, the torque is reliably increased while the torque ripple is reduced, compared to the case where the electric angle β is 90°, as shown in FIG. 3.

(5) The rotor 12 of the present embodiment is advantageous in terms of the torque and torque ripple in comparison with the rotor of Structure A and the rotor of Structure B. Also, compared to the rotor of Structure D, the rotor 12 is advantageous in terms of the strength.

A second embodiment of the present invention will now be described with reference to the drawings. The second embodiment is different from the first embodiment mainly in the number of tooth portions 23 (the number of slots) and the number of the magnetic poles of the rotor 12. The same reference numerals as in the first embodiment denote the same parts in the second embodiment, and a description thereof will be omitted.

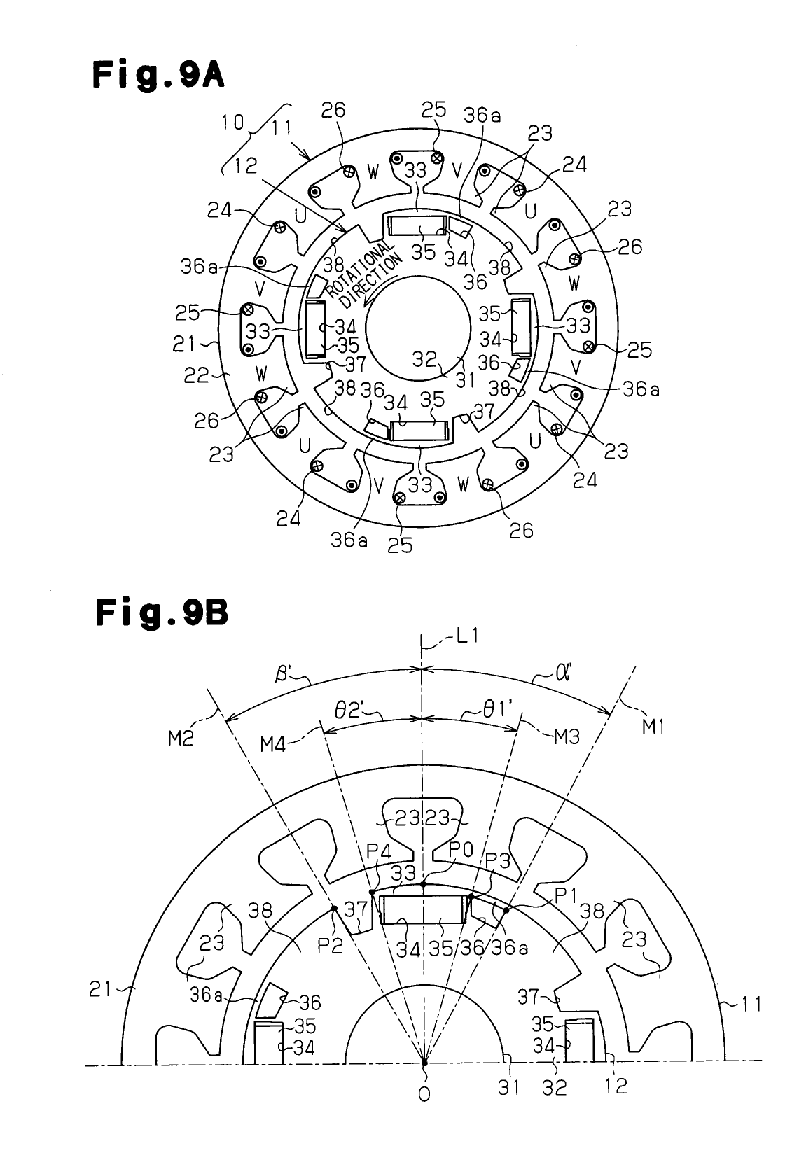

As shown in FIG. 9A, the stator core 21 includes an annular portion 22 and twelve tooth portions 23 extending radially inward from the annular portion 22. The tooth portions 23 are formed at equal angular intervals in the circumferential direction of the annular portion 22 in the same manner as that in the first embodiment. One of coils 24, 25, 26 of the U-phase, V-phase, and W-phase is wound about each tooth portion 23 by concentrated winding.

Magnetic pole portions 33 (the number of which is four in the present embodiment) are formed in the outer periphery of the rotor core 32. The magnetic pole portions 33 face the tooth portions 23 of the stator 11 in the radial direction.

As shown in FIGS. 9A and 9B, four accommodation holes 34 are formed in the magnetic pole portions 33 of the rotor core 32 at positions spaced by the mechanical angle of 90° in the circumferential direction and at radially outer positions of the rotor core 32. Each accommodation hole 34 extends through the rotor core 32 in the axial direction (the direction perpendicular to the sheet of the drawing). A magnet 35 is accommodated in each accommodation hole 34. The radially outer surfaces of the magnets 35 have the same polarity.

Gaps 36, 37, which create magnetic resistance, are formed at circumferential ends of each magnetic pole portion 33. Thus, salient pole portions 38 (the number of which is four in the present embodiment) are formed between the magnetic pole portions 33. Each salient pole portion 38 is magnetically partitioned from the magnetic pole portions 33.

In the following description, the motor 10 of the present embodiment is set to rotate in one direction (counterclockwise direction as viewed in FIG. 9A). Each leading gap 37 is formed to open radially outward. On the radially outer side (outer circumferential side), each trailing gap 36 is closed by a coupling portion 36a that connects the magnetic pole portion 33 and the salient pole portion 38. That is, the coupling portions 36a closing the trailing gaps 36 and the outer circumferential surfaces of the magnetic pole portions 33 and the salient pole portions 38 are on the same circle.

The optimal design of the electric angles α, β of the present embodiment are determined in the same manner as that in the first embodiment. FIG. 2 shows the results of simulation that was performed with the electric angle β fixed to a reference electric angle of 90°, which corresponds to the mechanical angle of 22.5° in the second embodiment. On the other hand, FIG. 3 shows the results of simulation that was performed with the electric angle α fixed to a reference electric angle of 90°, which corresponds to the mechanical angle of 22.5° in the second embodiment. The rotor 12 of the present embodiment corresponds to “Structure C1” in FIGS. 2 and 3.

According to FIG. 2, the motor 10 generates a higher torque in the range of 90°<α<126° (22.5°<α′<31.5°), than when the electric angle α=90° (α′=22.5°). Also, the torque ripple is lower in the range of 90°<α<126° (22.5°<α′<31.5°) than when the electric angle β=90° (β′=22.5°).

According to FIG. 3, the motor 10 generates a higher torque in the range of 90°<β<126° (22.5°<β′<31.5°), than when the electric angle β=90° (β′=22.5°). Also, the torque ripple is lower in the range of 90°<β<126° (22.5°<β′<31.5°) than when the electric angle β=90° (β′=22.5°).

As described above, the approximately same changes in the torque and torque ripple are obtained when the electric angles α, β are set to the same values for the first embodiment, where the motor includes the rotor of four magnetic poles and the stator having six tooth portions (n=1), and the second embodiment, where the motor includes the rotor of eight magnetic poles and the stator having twelve tooth portions (n=2). In the same manner, the approximately same changes in the torque and torque ripple are obtained when the electric angles α, β are set to the same values for a motor having a rotor of 4n magnetic poles and a stator having 6n tooth portions where the value n is a positive integer more than 2.

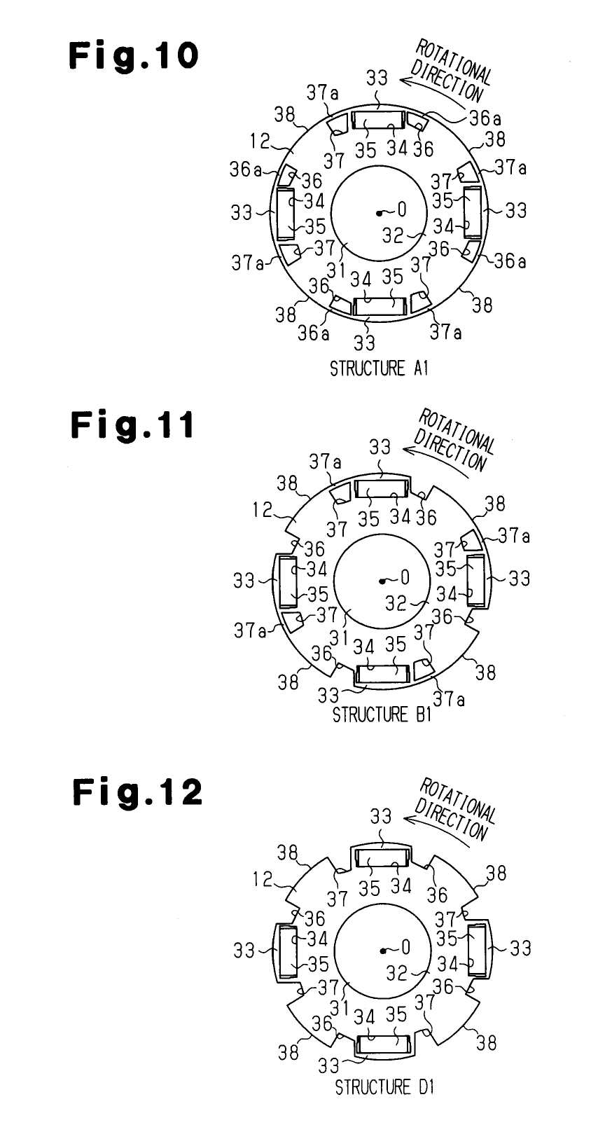

In the rotor 12 of the present embodiment, each leading gap 37 is open radially outward, and the trailing gaps 36 are closed by the coupling portions 36a. In this case, the rotor 12 of the present invention (Structure C1) generates greater torque and reduces the torque ripple compared to a rotor shown in FIG. 10 (Structure A1), in which gaps 36, 37 are both closed by coupling portions 36a, 37a, and a rotor shown in FIG. 11 (Structure B1), in which each leading gap 37 is closed by a coupling portion 37a and each trailing gap 36 opens radially outward. Also, compared to, for example, a rotor shown in FIG. 12 (Structure D1), in which both gaps 36, 37 are open, the rotor 12 of the present embodiment has a higher strength since the gaps 36 are closed by the coupling portions 36a.

According to the second embodiment, in addition to the advantages of the first embodiment, the following advantage can be obtained.

(6) The rotor 12 of the present embodiment is advantageous in terms of the torque and torque ripple in comparison with the rotor of Structure A1 and the rotor of Structure B1. Also, compared to the rotor of Structure D1, the rotor 12 is advantageous in terms of the strength.

The preferred embodiments of the present invention may be modified as follows.

In the above embodiments, the leading gap 37 of the gaps 36, 37 adjacent to each magnetic pole portion 33 is open radially outward, that is, is formed without a coupling portion, while the trailing gaps 36 are closed by the coupling portions 36a (Structures C and C1). Instead, for example, a rotor shown in FIGS. 6 and 10 (Structures A and A1) may be used, in which both gaps 36, 37 are closed by coupling portions 36a, 37a, respectively. Also, a rotor shown in FIGS. 7 and 11 (Structures B and B1) may be used, in which the leading gaps 37 are closed by coupling portions 37a, and the trailing gaps 36 open radially outward. Further, a rotor shown in FIGS. 8 and 12 (Structures D and D1) may be used, in which both gaps 36, 37, which are adjacent to each magnetic pole portion 33 are open radially outward. In other words, a rotor having no coupling portions may be used.

In the above embodiments, the electric angles α, β, which correspond to the mechanical angles α′, β′ that define the circumferential dimensions of the gaps 36, 37, are set to approximately 115° and approximately 105°, respectively. That is, both of the electric angles α, β are changed from 90° (the mechanical angle of 45° or 22.5°), which is a reference angle, to angles in favorable ranges. Instead, only one of the electric angles α, β may be changed to an angle in the favorable range.

What is claimed is:

1. A motor comprising:
a rotor of magnetic poles having a rotor core, magnets, and salient pole portions, the numbers of the magnetic poles, the magnets, and the salient pole portions being represented by 4n, 2n, and 2n, respectively, the value n being a positive integer, the magnets being arranged along the circumferential direction of the rotor core and embedded in the rotor core to function as 2n of the magnetic poles having one magnetic polarity, the salient pole portions being arranged along the circumferential direction and integrally formed with the rotor core, each salient pole portion being located
circumferentially between the magnets, wherein the salient pole portions function as 2n of the magnetic poles having the other magnetic polarity, and a gap is provided between each magnet and a circumferentially adjacent one of the salient pole portions; and
a stator having tooth portions, the number of the tooth portions being represented by 6n, and coils, wherein the tooth portions are arranged circumferentially at equal intervals to face the magnets and the salient pole portions in the radial direction, and each coil is wound about one of the tooth portions, wherein
the gaps located at the circumferential ends of each magnet include a trailing gap, which is on a trailing side of the magnet, and
an electric angle α that corresponds to a mechanical angle α′ defined by a reference straight line, which passes through a central axis of the rotor and the circumferential center position of each magnet, and a straight line, which passes through the central axis of the rotor and a trailing end of each trailing gap, is set in the range of 90°<α<126°.

2. The motor according to claim 1, wherein the electric angle α is in the range of 110°≦α≦120°.

3. The motor according to claim 1, wherein
the gaps located at the circumferential ends of each magnet include a leading gap, and
an electric angle β that corresponds to a mechanical angle β defined by the reference straight line and a straight line, which passes through the central axis of the rotor and a leading end of each leading gap, is set in the range of 90°<β<126°.

4. The motor according to claim 3, wherein the electric angle β is in the range of 104°≦β≦116°.

5. A motor comprising:
a rotor of magnetic poles having a rotor core, magnets, and salient pole portions, the numbers of the magnetic poles, the magnets, and the salient pole portions being represented by 4n, 2n, and 2n, respectively, the value n being a positive integer, the magnets being arranged along the circumferential direction of the rotor core and embedded in the rotor core to function as 2n of the magnetic poles having one magnetic polarity, the salient pole portions being arranged along the circumferential direction and integrally formed with the rotor core, each salient pole portion being located circumferentially between the magnets, wherein the salient pole portions function as 2n magnetic poles having the other magnetic polarity, and a gap is provided between each magnet and a circumferentially adjacent one of the salient pole portions; and
a stator having tooth portions, the number of the tooth portions being represented by 6n, and coils, wherein the tooth portions are arranged circumferentially at equal intervals to face the magnets and the salient pole portions in the radial direction, and each coil is wound about one of the tooth portions, wherein
the gaps located at the circumferential ends of each magnet include a leading gap, which is on a leading side of the magnet, and
an electric angle β that corresponds to a mechanical angle β′ defined by a reference straight line, which passes through a central axis of the rotor and the circumferential center position of each magnet, and a straight line, which passes through the central axis of the rotor and a leading end of each leading gap, is set in the range of 90°<β<126°.
